(19) United States
(12) Patent Application Publication
(10) Pub. No.: US 2022/0148221 A1
(43) Pub. Date: May 12, 2022

(54) Optical Device Validation

(71) Applicant: Argo Al, LLC, Pittsburgh, PA (US)

(72) Inventors: Morgan M. Wagner, Pittsburgh, PA (US); Michel H.J. Laverne, Pittsburgh, PA (US); Nikolas Stewart, Santa Cruz, CA (US); Casey J. Sennott, Pittsburgh, PA (US); Larry Lenkin, Ferndale, MI (US)

(73) Assignee: Argo AI, LLC, Pittsburgh, PA (US)

(21) Appl. No.: 17/096,777

(22) Filed: Nov. 12, 2020

(51) Int. Cl. G06T 7/80; G01S 17/931; G01S 13/931; G01S 7/40; G01S 7/497

(52) U.S. Cl. CPC G06T 7/80; G01S 17/931; G01S 13/931; G01S 7/4021; G01S 2013/93273; G06T 2207/30252; G01S 2013/93271; G01S 2013/93272; G01S 7/497

(57) ABSTRACT

Devices, systems, and methods are provided for optical device validation. For example, a system may comprise an optical device operable to emit or absorb light, wherein the optical device comprises a lens having an outer surface. The system may comprise a camera positioned in a line of sight of the optical device, wherein the camera is operable to capture one or more images of the optical device. The system may comprise a computer system in communication with to the camera and operable to calculate a validation score for a captured image of the one or more images and to validate the optical device based on a validation state generated using the calculated validation score.

### TECHNICAL FIELD

This disclosure generally relates to systems and methods for optical device validation.

### BACKGROUND

Vehicles may be equipped with sensors to collect data relating to the current and developing state of the vehicle's surroundings. Vehicles at any level of autonomy depend on data from these sensors that have an optical element to them, such as, cameras, radars, LIDARs, headlights, etc. The proper performance of a vehicle depends on the accuracy of the data collected by the sensors. Environmental factors like rain, dust, snow, mud, bugs, and any other obstructions that can be deposited on the lens may have an impact on the performance of sensors on the vehicle. Evaluating how these obstructions affect these sensors necessitates a controlled testing environment as well as post-processing of the data. This challenge is magnified when co-developing sensor systems in partnership with suppliers and original equipment manufacturers (OEMs) because of the need to quickly and efficiently iterate in various environments including but not limited to rain chambers, wind tunnels, dust chambers, garages, and test tracks with the vehicle stationary or in motion. Therefore, there is a need to enhance the validation of sensor-related equipment to ensure that obstructions do not undermine the performance of the sensors.

### BRIEF DESCRIPTION OF THE DRAWINGS

FIG. 1 illustrates example environment of a vehicle, in accordance with one or more example embodiments of the present disclosure.

FIG. 2 depicts an illustrative schematic diagram for optical device validation, in accordance with one or more example embodiments of the present disclosure.

FIG. 3 depicts an illustrative schematic diagram for optical device validation, in accordance with one or more example embodiments of the present disclosure.

FIG. 4 depicts an illustrative schematic diagram for optical device validation, in accordance with one or more example embodiments of the present disclosure.

FIG. 5 is a block diagram illustrating an example of a computing device or computer system upon which any of one or more techniques (e.g., methods) may be performed, in accordance with one or more example embodiments of the present disclosure.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers in the figures refer to like elements throughout. Hence, if a feature is used across several drawings, the number used to identify the feature in the drawing where the feature first appeared will be used in later drawings.

### DETAILED DESCRIPTION

Sensors may be located at various positions on an autonomous vehicle. These sensors may include LIDAR sensors, stereo cameras, radar sensors, thermal sensors, or other sensors attached to an autonomous vehicle. These sensors may be originally used in a lab environment in order to perform high precision analyses of their performance under certain conditions. Autonomous vehicles may be driven in the real world and rely on the attached sensors to perform to a certain performance level under environmental factors. As the autonomous vehicles are driven in the real world, the sensors are exposed to these environmental factors but also there may be more factors than what was tested in the lab environment. This may be due to various conditions that may occur in the real world that are different from a controlled lab environment. This may create a new environment and various consequences based on this new environment. One of the challenges that may be faced by exposing the sensors to a new environment is attempting to restore the sensors to a state close to the original state.

Sensors may be exposed to obstructions that could get deposited on the lenses of the sensors or may block the sensors. Some of the obstructions may include debris, mud, rain droplets, or any other objects that would hinder the normal operation of a sensor. In some embodiments, an autonomous vehicle may comprise a cleaning system associated with cleaning obstruction on sensors of the autonomous vehicle. One challenge may be determining if a cleaning system of an autonomous vehicle has adequately cleaned the sensors in their lenses such that the sensors are restored to a state that is close to an original state of the sensors.

Example embodiments described herein provide certain systems, methods, and devices for optical device performance validation.

In one or more embodiments, an optical device validation system may facilitate the setup of an optical device (e.g., a sensor, a headlamp, or any optical device that utilizes an optical path) of a vehicle such that the optical device is exposed to an obstruction environment. An optical device should not be interrupted from its normal function. For example, if an obstruction is deposited on the lens of a camera, may result in a degradation of the camera's performance. In some scenarios, a camera cleaning system may be applied in order to attempt to return the camera to its normal function by clearing the obstruction off of the camera lens to a certain degree.

In one or more embodiments, an optical device validation system may facilitate a validation test for an optical device (e.g., a sensor or even a headlight) under test. An optical device validation system may provide a mechanism to allow a pass or fail criteria to be judged on the optical device under test in real-time during the testing and provides a target framework and a backend processing framework together in real-time application.

In one or more embodiments, an optical device validation system may facilitate an application-independent methodology by using a validation metric associated with the validation of an optical device. That is, the ability to measure the optical device's quantitative value of the obstruction deposited on the outer surface of an optical device and compared to a validation metric. The validation metric may be described in the notion of a passing state and the notion of interrupted or fail state based on the presence of an obstruction on the outer surface of an optical device (e.g., a lens of a sensor).

In one or more embodiments, an optical device validation system may facilitate a generalized pass or fail criteria independent of the application of the sensor, under a degraded event, yet still be relevant to a broad set of applications (e.g., recognizing faces, cars, etc.). Therefore, an optical device validation system would lend itself to a pass or fail judgment and a notion of using a validation metric to evaluate whether an optical device is performing to a predetermined level.

In one or more embodiments, an optical device validation system may utilize a validation metric, referred to throughout this disclosure as a cosmetic correlation to cleaning metric (CCCM). It should be understood that the use of CCCM is only an example of a validation metric, which may be different based on implementation. A CCCM may be represented as a CCCM score that estimates an optical device's performance based on what the outer surface of an active area of the optical device looks like. For example, images may be taken of an optical device, which in turn may be passed to an algorithm that processes these images and assigns them a CCCM score. The CCCM score may be compared to a validation threshold. A CCCM score higher than the validation threshold may indicate a passing state. On the other hand, a CCCM score lower than the validation threshold may indicate a fail state. The active area of the optical device may be considered as a useful area of the lens that would allow the capture of data associated with the optical device. For example, when images are taken of the optical device, the optical device validation system may facilitate cropping the active area of the optical device. The optical device validation system may detect where the obstruction is on the outer surface of the optical device. The optical device validation system may quantify the obstruction. For example, determine how many pixels are obstructed versus not obstructed.

In one or more embodiments, an optical device validation system may capture a plurality of images of an optical device placed at a specific distance from the camera taking the images. Because of that, the CCCM score represents how obstructed an active area of an optical device is. The optical device validation system may compare the scores of a quality metric to the CCCM scores calculated for these images. This results in the creation of various CCCM charts that would later be used to validate other images taken of the optical device during a validation test. CCCM charts may contain images of an optical device lens with various levels of obstructions. The chart allows a user to determine if the optical device being tested will pass or fail based on the level of obstruction being deposited on its outer surface. In some instances, a cleaning system may be evaluated to determine a relative CCCM score after a lens of an optical device has been cleaned. That is, after the application of an obstruction that results in degradation of the performance of the optical device. The calculated CCCM score after the cleaning process may then be compared to a validation threshold to determine whether the cleaning system is performing to its intended effectiveness. For example, if the CCCM score is above the validation threshold, this indicates that the cleaning system has passed the validation test. However, if the CCCM score is below the validation threshold, this indicates that the cleaning system has failed the validation test.

In one or more embodiments, the validation metric may be originally correlated to any quality metric that can be used to verify the accuracy of the validation metric. In some other examples, the validation metric may be correlated to a vehicle performance metric. Some examples include the detection of an object or tracking of an object. It should be understood that the validation metric is not limited to being correlated to vehicle performance or quality performance. In one example, in the case of a camera, a structural similarity index measurement (SSIM) quality metric may be used to verify the validation metric (e.g., CCCM) as opposed to being part of the validation process of the optical device. In other words, the validation process of an optical device relies on the validation metric (e.g., CCCM) and not the quality metric (e.g., SSIM). It should be understood that the validation metric (e.g., CCCM) is a standalone process for validating the performance of an optical device in the presence of some obstruction on the outer surface of the optical device. CCCM may be applied to any optical device that has an optical element to it, for example, an emitting element or an absorbing element. It does not matter which direction of light signals the optical device is emitted when characterizing how clean an outer surface of the optical device is. For example, a headlamp may be determined to be obstructed due to accumulation of environmental factors like rain, dust, snow, mud, bugs, and any other obstructions that can be deposited on the lens of the headlamp, which in turn may affect other sensors on the vehicle attempting to capture data in a dark surrounding. Therefore, using a validation metric such as CCCM may result in determining whether the headlamp is performing below or above a validation threshold.

In one or more embodiments, the CCCM may be a perceptual metric that quantifies degradation caused by an obstruction that may be present on the outer surface of an optical device. For example, the CCCM may be calculated directly from an image taken of the outer surface of an optical device. CCCM is an absolute measurement and it does not need to be correlated to a dirty versus clean cycle. CCCM can be applied to any optical device under any condition regardless of the intended use of the optical device.

In one or more embodiments, an optical device validation system may facilitate a novel linkage of calculating a validation metric (e.g., CCCM) to an optical device under the introduction of an obstruction to the lens of the optical device. The optical device may be related to LIDARs, radars, cameras, headlamps, cameras, or any optical device that utilizes an optical path.

In one or more embodiments, an optical device validation system may facilitate calculating a CCCM score for an image captured by a camera of the outside surface of an optical device when the optical device is subjected to the obstruction. The calculated CCCM score may then be compared to a validation threshold and based on that, the optical device validation system may, quickly and independently from the application of the optical device, determine whether the optical device is performing to an expected level. The determination of the threshold is based on the type of sensor, the type of obstruction, and implementation. For example, some sensors may have a lower validation threshold than other sensors. Any performance metric may be used as a guide of what the validation threshold should be.

The above descriptions are for purposes of illustration and are not meant to be limiting. Numerous other examples, configurations, processes, etc., may exist, some of which are described in greater detail below. Example embodiments will now be described with reference to the accompanying figures.

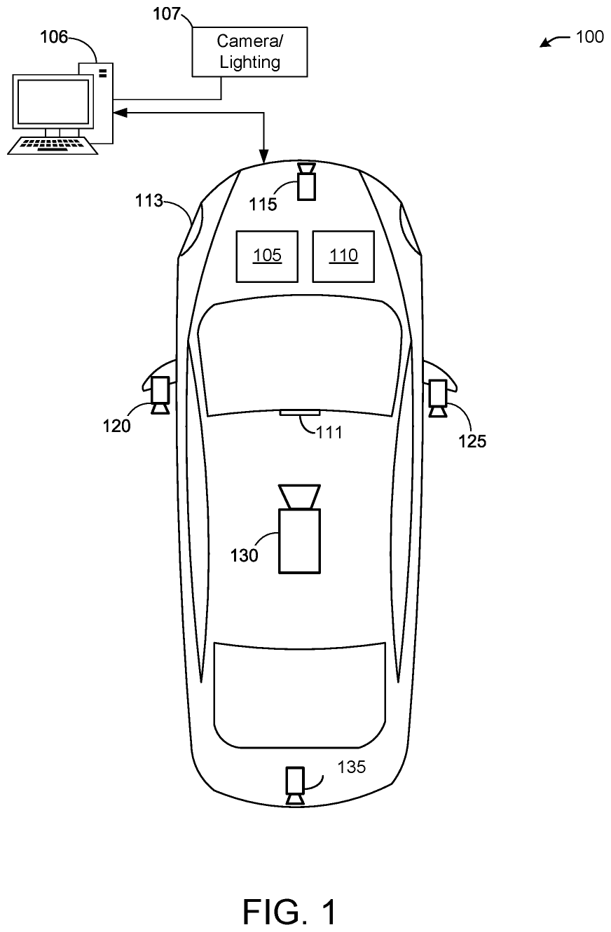

FIG. 1 illustrates an exemplary vehicle 100 equipped with multiple sensors. The vehicle 100 may be one of the various types of vehicles such as a gasoline-powered vehicle, an electric vehicle, a hybrid electric vehicle, or an autonomous vehicle, and can include various items such as a vehicle computer 105 and an auxiliary operations computer 110. The exemplary vehicle 100 may comprise many electronic control units (ECUs) for various subsystems. Some of these subsystems may be used to provide proper operation of the vehicle. Some examples of these subsystems may include a braking subsystem, a cruise control subsystem, power windows, and doors subsystem, a battery charging subsystem for hybrid and electric vehicles, or other vehicle subsystems. Communication between the various subsystems is an important feature of operating vehicles. A controller area network (CAN) bus may be used to allow the subsystems to communicate with each other. Such communications provide a wide range of safety, economy, and convenience features to be implemented using software. For example, sensor inputs from the various sensors around the vehicle may be communicated between the various ECUs of the vehicle via the CAN bus to perform actions that may the essential to the performance of the vehicle. An example may include auto lane assist and/or avoidance systems where such sensor inputs are used by the CAN bus to communicate these inputs to the driver-assist system such as lane departure warning, which in some situations may actuate breaking an active avoidance system.

The vehicle computer 105 may perform various functions such as controlling engine operations (fuel injection, speed control, emissions control, braking, etc.), managing climate controls (air conditioning, heating, etc.), activating airbags, and issuing warnings (check engine light, bulb failure, low tire pressure, a vehicle in a blind spot, etc.).

The auxiliary operations computer 110 may be used to support various operations in accordance with the disclosure. In some cases, some or all of the components of the auxiliary operations computer 110 may be integrated into the vehicle computer 105. Accordingly, various operations in accordance with the disclosure may be executed by the auxiliary operations computer 110 in an independent manner. For example, the auxiliary operations computer 110 may carry out some operations associated with providing sensor settings of one or more sensors in the vehicle without interacting with the vehicle computer 105. The auxiliary operations computer 110 may carry out some other operations in cooperation with the vehicle computer 105. For example, the auxiliary operations computer 110 may use information obtained by processing a video feed from a camera to inform the vehicle computer 105 to execute a vehicle operation such as braking.

One or more sensors may include LIDAR sensors, stereo cameras, radar sensors, thermal sensors, or other sensors attached to an autonomous vehicle. In additions to the one or more sensors, the headlight (e.g., headlight 113) may require validation to ensure proper operation in the presence of debris, mud, rain, bugs, or other obstructions that hinder the normal operation of the headlight. An obstructed headlight may result in other sensors on the vehicle not being capable to capture reliable data (e.g., cameras may not be able to capture clear images due to obstructed light emitted from a headlight in a dark environment).

In the illustration shown in FIG. 1, the vehicle 100 is shown to be equipped with five sensors, which are used here for illustrative purposes only and not meant to be limiting. In other scenarios, fewer or a greater number of sensors may be provided. The five sensors may include a front-facing sensor 115, a rear-facing sensors 135, a roof-mounted sensor 130, a driver-side mirror sensor 120, and a passenger-side mirror sensor 125. The front-facing sensor 115, which may be mounted upon one of various parts in the front of the vehicle 100, such as a grille or a bumper, produces sensor data that may be used, for example, by the vehicle computer 105 and/or by the auxiliary operations computer 110, to interact, for example, with an automatic braking system of the vehicle 100. The automatic braking system may slow down the vehicle 100 if the sensor data produced by the front-facing sensor 115 indicate that the vehicle 100 is too close to another vehicle traveling in front of the vehicle 100.

Any of the various sensors (e.g., sensors 115, 120, 125, 130, and 135) should not be interrupted from its normal function under the presence of obstructions such as debris, mud, rain, bugs, or other obstructions that hinder the normal operation of the sensor. Captured data by the sensors (e.g., sensors 115, 120, 125, 130, and 135) may be raw data that is sent to a vehicle computer 105 and/or by the auxiliary operations computer 110 in order to convert the raw data into processed signals. Therefore, it is desirable to enhance the testing and validation of these various sensors before real-world applications (e.g., being on the road) to ensure that they do not provide inconsistent or unreliable data that undermines their normal operation.

The rear-facing sensor 135 may be a camera that may be used, for example, to display upon a display screen of an infotainment system 111, images of objects located behind the vehicle 100. A driver of the vehicle 100 may view these images when performing a reversing operation upon the vehicle 100.

The roof-mounted sensor 130 may be a part of an autonomous driving system when the vehicle 100 is an autonomous vehicle, such as a LIDAR. Images produced by the roof-mounted sensor 130 may be processed by the vehicle computer 105 and/or by the auxiliary operations computer 110 for detecting and identifying objects ahead and/or around the vehicle. The roof-mounted sensor 130 can have a wide-angle field-of-view and/or may be rotatable upon a mounting base. The vehicle 100 can use information obtained from the image processing to navigate around obstacles.

The driver-side mirror sensor 120 may be used for capturing data associated with vehicles in an adjacent lane on the driver side of the vehicle 100 and the passenger-side mirror sensor 125 may be used for example for capturing images or detecting vehicles in adjacent lanes on the passenger side of the vehicle 100. In an exemplary application, data captured by the driver-side mirror sensor 120, the passenger-side mirror sensor 125, and the rear-facing sensor 135 may be combined by the vehicle computer 105 and/or by the auxiliary operations computer 110 to produce a computer-generated useable data that provides a 360-degree field-of-coverage around the vehicle 100. The computer-generated useable data may be displayed upon a display screen of the infotainment system 111 to assist the driver to drive the vehicle 100.

The various sensors provided in the vehicle 100 can be any of various types of sensors and can incorporate various types of technologies. For example, one of the sensors may be a night-vision camera having infra-red lighting that may be used for capturing images in low light conditions. The low light conditions may be present, for example, when the vehicle 100 is parked at a spot during the night. The images captured by the night-vision camera may be used for security purposes such as for preventing vandalism or theft. A stereo camera may be used to capture images that provide depth information that may be useful for determining separation distance between the vehicle 100 and other vehicles when the vehicle 100 is in motion. In another application where minimal processing latency is desired, a pair of cameras may be configured for generating a high frame-rate video feed. The high frame-rate video feed may be generated by interlacing the video feeds of the two cameras. In another example, the sensor may be a radar that may be used to detect objects in the vicinity of the vehicle. In yet another application, a sensor may be a light detection and ranging (LIDAR) used to detect and capture images of objects in the line of sight of the vehicle. Some LIDAR applications can include long-distance imaging and/or short distance imaging.

In one or more embodiments, an optical device validation system may facilitate the setup of a sensor (e.g., sensors 115, 120, 125, 130, or 135) in a test environment which may be constrained in both its required setup as well as the environment it is in. Sensors (e.g., Sensors 115, 120, 125, 130, and 135) may be subjected to obstructions before being introduced in real-world scenarios where the sensors need to operate at an optimal level to ensure quality data are being captured and processed with minimal errors. A sensor (e.g., sensors 115, 120, 125, 130, or 135) may be interrupted from its normal function under the presence of an obstruction, which would alter the data quality captured by the sensor. For example, obstructions may include debris, mud, rain, bugs, or other obstructions that hinder the normal operation of the camera. These obstructions may cause interference and alteration of the data quality of a sensor. It is important to note that obstruction can reduce the data quality in any combination of a uniform obstruction or a single or series of localized obstructions.

As explained, an optical device should not be interrupted from its normal function. For example, an obstruction deposited on the lens of any of the sensors (e.g., sensors 115, 120, 125, 130, or 135) or the headlight 113, may result in a degradation of the optical device performance. It would be beneficial to validate whether the obstruction on the lens of these sensors or headlight results in degradation beyond a predetermined level, which renders a fail result of the validation.

In one or more embodiments, an optical device validation system may facilitate a validation test for any of the sensors (e.g., sensors 115, 120, 125, 130, or 135) or the headlight (e.g., headlight 113) under test using an implementation-specific hardware setup that may include a validation computer system 106 and a camera/lighting setup 107. It should be understood that the camera/lighting setup 107 may vary and may comprise additional components, such as a glare shield. The camera and lighting setup may facilitate illuminating the optical device (e.g., any of the sensors 115, 120, 125, 130, 135, or the headlight 113) while a camera may capture images of the optical device. These images may be fed to the validation computer system 106 for further processing.

An optical device validation system may provide a mechanism to allow a pass or fail criteria to be judged on the optical device under test in real-time during the testing and provides a target framework and a backend processing framework together in real-time application. For example, using the validation computer system 106, a validation metric, such as CCCM may be used evaluate whether an obstruction results in a pass or fail of the performance of an optical device of the vehicle 100. It should be understood that the use of CCCM is only an example of a validation metric, which may be different based on implementation. A CCCM may be represented as a CCCM score that estimates an optical device's performance based on what the outer surface of an active area of the optical device looks like. The CCCM score of an image taken of any of the sensors (e.g., sensors 115, 120, 125, 130, or 135) or the headlight 113 may be compared to a validation threshold. In some examples, a CCCM score higher than the validation threshold indicates a passing state. On the other hand, a CCCM score lower than the validation threshold indicates a fail state. When an image is taken of any of these optical devices (e.g., sensors 115, 120, 125, 130, 135, or the headlight 113), the image may then be processed by the validation computer system 106. The validation module may determine the active area in the image based on the optical device that may be considered a useful area of the lens that would allow the capture of data associated with the optical device. For example, when images are taken of the optical device, the optical device validation system may facilitate cropping the active area of the optical device. The optical device validation system may detect where the obstruction is on the outer surface of the optical device. The optical device validation system may quantify the obstruction. For example, determine how many pixels are obstructed versus not obstructed.

In one or more embodiments, an optical device validation system may capture a plurality of images, using the camera/lighting setup 107 of an optical device placed at a specific distance from the camera of the camera/lighting setup 107 taking the images. Because of that, the CCCM score represents how obstructed an active area of an optical device is. The image data may be passed to the validation computer system 106, which may calculate a CCCM score of each image taken. The calculated CCCM score may then be compared to a validation threshold to determine whether the optical device is performing to its intended effectiveness. For example, if the CCCM score is above the validation threshold, this indicates that the optical device has passed the validation test. However, if the CCCM score is below the validation threshold, this indicates that the optical device has failed the validation test.

It is understood that the above descriptions are for purposes of illustration and are not meant to be limiting.

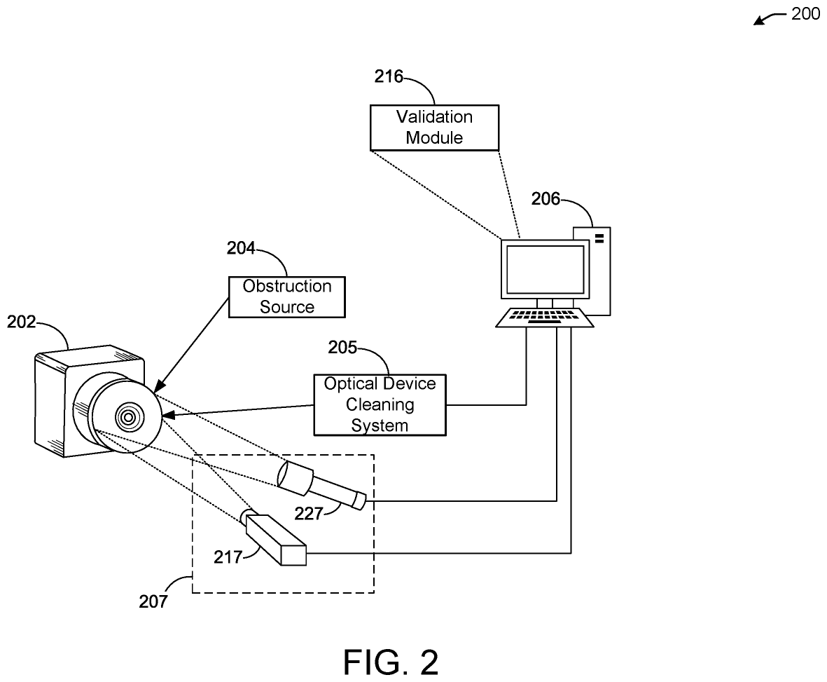

FIG. 2 depicts an illustrative schematic diagram for optical device validation, in accordance with one or more example embodiments of the present disclosure.

Referring to FIG. 2, there is shown an optical device validation system 200 for verifying the status of an optical device 202. The optical device validation system 200 may comprise a computer system 206, an optical device cleaning system 205, an obstruction source 204, and hardware set up 207 for capturing images of the optical device 202.

The computer system 201 may also provide a system administrator access to inputs and outputs of the optical device validation system 200. The computer system 201 may control the optical device validation system 200 by adjusting parameters associated with the various components of the optical device validation system 200. The optical device 202 or any other cameras discussed in the following figures may be any of the optical devices depicted and discussed in FIG. 1.

The hardware set up 207 may comprise a camera 217 and a lighting source 227 that may be directed towards the optical device 202. The camera 217 may be positioned at a specific distance from the optical device 202. The lighting source 227 may be positioned in front of the optical device 202 to illuminate an outer surface, such as a lens, of the optical device 202. The camera 217 may capture one or more images of the optical device 202 which may then be sent and processed by the computer system 206. Under normal conditions, the optical device 202 may be free of any debris on its lens, which causes it to operate to its intended purpose. The captured images may be raw data that may be sent to be computer system 206 to perform a validation of the optical device 202. This may be accomplished by assigning a score to the captured image and verifying whether the score is above or below a certain validation threshold. The obstruction source may introduce obstruction such as

The computer system 206 may evaluate a captured image of the optical device 202 to determine CCCM scores of an active area associated with the lens of the optical device 202.

In one or more embodiments, an optical device validation system 200 may capture an image using the camera 217 after an obstruction is applied to the camera lens using the obstruction source 208. The captured image may be associated with an obstruction level that has been introduced to the optical device 202 using the obstruction source 208.

In one or more embodiments, computer system 206 may not be limited to validating an optical device 202 but also can be used to validate the optical device cleaning system 205. The computer system 206 may determine whether, after application of the optical device cleaning system 205, the optical device cleaning system 205 is considered to be in a pass or fail state. This validates the effectiveness of the optical device cleaning system 205 to mitigate the obstructions that may have been introduced on the lens of the optical device 202. The optical device cleaning system 205 may apply fluids through a nozzle or airflow to the lens in an attempt to remove the obstruction introduced by the obstruction source 208. The application of fluids or airflow may be controlled by the optical device cleaning system 205 in order to vary the concentration and pressure of fluids, the speed of the airflow, and/or the angle of the fluid nozzle or the airflow nozzle. In addition, the direction of fluids and airflow may be also controlled by the optical device cleaning system 205.

In one or more embodiments, an optical device validation system may capture an image of the optical device 202 after the application of the optical device cleaning system 205. The computer system 206 may evaluate a post-cleaning image captured by the camera 217 to determine a post-cleaning CCCM score of the captured post-cleaning image. This new CCCM score may then be compared to the validation threshold to determine whether the optical device cleaning system 205 passes or fails validation.

In one or more embodiments, an optical device validation system 200 may determine whether the optical device 202 operations has been disrupted by the introduction of obstructions using the obstruction source 208 to a point to classify the optical device 202 to be in a failed state. For example, the CCCM score calculated by the computer system 206 may be compared to a validation threshold. In case the CCCM score is below the validation threshold, the optical device 202 may be considered to be in a failed state. However, if the CCCM score is above the validation threshold, the optical device 202 may be considered to be in a passing state.

It is understood that the above descriptions are for purposes of illustration and are not meant to be limiting.

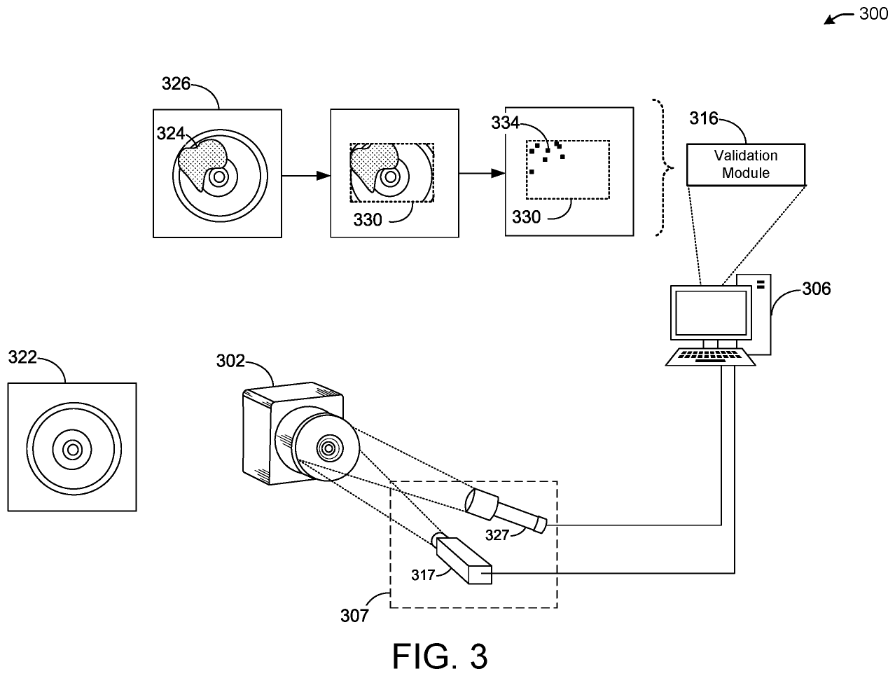

FIG. 3 depicts an illustrative schematic diagram for optical device validation, in accordance with one or more example embodiments of the present disclosure.

Referring to FIG. 3, there is shown a testing environment 300 that may comprise an optical device 302 under test, a validation computer 306, a hardware set up 307 comprised of a camera 317 and a lighting source 327. It should be understood that the hardware set up 307 may vary and may comprise additional components, such as a glare shield. The hardware set up 307 may be mounted onto a tripod or directly onto the vehicle. The camera 317 may capture images of the optical device. These images may be fed to the validation computer system 306 for further processing. The camera 317 may be placed at a specific distance from the optical device 302.

The validation computer system 306 may comprise a validation module 316 responsible for processing the images captured by the camera 317. Further, the validation module 316 may perform the calculation of a validation metric associated with an image captured by the camera 317. The validation module 316 may first receive data associated with an image that was captured by the camera 317 of the lens of the optical device 302. Before the application of an obstruction to the lens of the optical device 302, an image 322 may be captured, which should correlate to a validation metric value or score that indicates a passing state. In the case of validating the optical device 302 after it has been subjected to an obstruction, an image 326 may be captured by the camera 317 which also captures the obstruction 324 on the lens of the optical device 302. The validation module 316 may receive that image as an input and may detect the lens area in that image 326. After the validation module 316 detects the lens area, it proceeds to auto crop that area into a critical or an active area 330 that may be defined for that lens. The validation module 316 may process the data contained within the critical or active area 330 to determine how the obstruction may be covering some of the pixels of the lens surface. The obstructed pixels 334 are shown to cover a portion of the critical or active area 330. The validation module 316 may then calculate a CCCM score that may be given based on the obstructed pixels 334. As explained above, the CCCM score represents how obstructed an active area of an optical device is. The calculated CCCM score may then be compared to a validation threshold to determine whether the optical device is performing to its intended effectiveness. For example, if the CCCM score associated with image 326 is above the validation threshold, this indicates that the optical device 302 has passed the validation test. However, if the CCCM score is below the validation threshold, this indicates that the optical device 302 has failed the validation test.

It is understood that the above descriptions are for purposes of illustration and are not meant to be limiting.

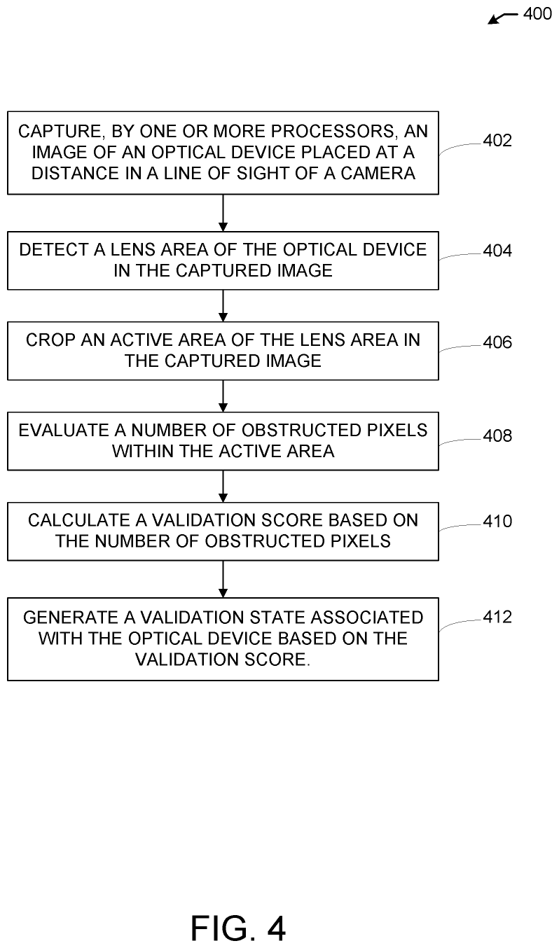

FIG. 4 illustrates a flow diagram of process 400 for an illustrative optical device validation system, in accordance with one or more example embodiments of the present disclosure.

At block 402, a system may capture an image of an optical device placed at a distance in a line of sight of a camera. The optical device comprises a camera, a light detection and ranging (LIDAR), a radar, or a vehicle light.

At block 404, the system may detect a lens area of the optical device in the captured image.

At block 406, the system may crop an active area of the lens area in the captured image.

At block 408, the system may evaluate a number of obstructed pixels within the active area. The system may detect the number of obstructed pixels based on an obstruction on an outer surface of the lens area of the optical device.

At block 410, the system may calculate a validation score based on the number of obstructed pixels. The validation score is associated with the number of obstructed pixels on an outer surface of the lens area of the optical device. The validation score is a cosmetic correlation to cleaning metric (CCCM) score. The validation state is a failed state or a passing state. The system may compare the validation score to a validation threshold; and setting the validation state to a failed state based on the validation score being less than the validation threshold.

At block 412, the system generate a validation state associated with the optical device based on the validation score. The system may compare the validation score to a validation threshold; and setting the validation state to a passing state based on the validation score being greater than or equal to the validation threshold.

It is understood that the above descriptions are for purposes of illustration and are not meant to be limiting.

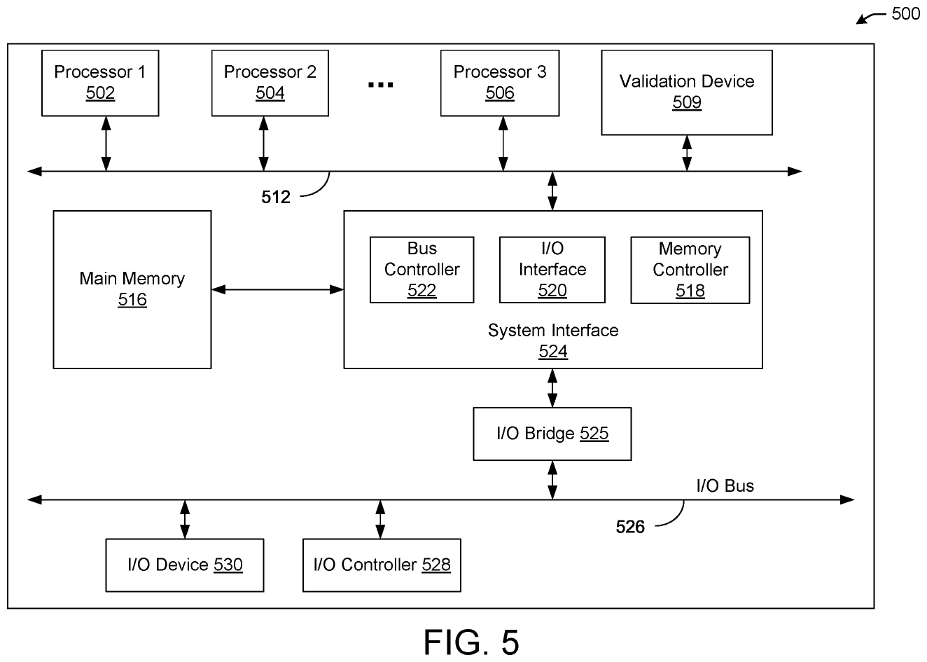

FIG. 5 is a block diagram illustrating an example of a computing device or computer system 500 upon which any of one or more techniques (e.g., methods) may be performed, in accordance with one or more example embodiments of the present disclosure.

For example, the computing system 500 of FIG. 5 may represent the one or more processors 132 and/or the computer systems of FIG. 1, FIG. 2, and FIG. 3. The computer system (system) includes one or more processors 502-506. Processors 502-506 may include one or more internal levels of cache (not shown) and a bus controller (e.g., bus controller 522) or bus interface (e.g., I/O interface 520) unit to direct interaction with the processor bus 512. A validation device 509 may also be in communication with the Processors 502-506 and may be connected to the processor bus 512.

Processor bus 512, also known as the host bus or the front side bus, may be used to couple the processors 502-506 and/or the validation device 509 with the system interface 524. System interface 524 may be connected to the processor bus 512 to interface other components of the system 500 with the processor bus 512. For example, system interface 524 may include a memory controller 518 for interfacing a main memory 516 with the processor bus 512. The main memory 516 typically includes one or more memory cards and a control circuit (not shown). System interface 524 may also include an input/output (I/O) interface 520 to interface one or more I/O bridges 525 or I/O devices 530 with the processor bus 512. One or more I/O controllers and/or I/O devices may be connected with the I/O bus 526, such as I/O controller 528 and I/O device 530, as illustrated.

I/O device 530 may also include an input device (not shown), such as an alphanumeric input device, including alphanumeric and other keys for communicating information and/or command selections to the processors 502-506 and/or the validation device 509. Another type of user input device includes cursor control, such as a mouse, a trackball, or cursor direction keys for communicating direction information and command selections to the processors 502-506 and/or the validation device 509 and for controlling cursor movement on the display device.

System 500 may include a dynamic storage device, referred to as main memory 516, or a random access memory (RAM) or other computer-readable devices coupled to the processor bus 512 for storing information and instructions to be executed by the processors 502-506 and/or the validation device 509. Main memory 516 also may be used for storing temporary variables or other intermediate information during execution of instructions by the processors 502-506 and/or the validation device 509. System 500 may include read-only memory (ROM) and/or other static storage device coupled to the processor bus 512 for storing static information and instructions for the processors 502-506 and/or the validation device 509. The system outlined in FIG. 5 is but one possible example of a computer system that may employ or be configured in accordance with aspects of the present disclosure.

According to one embodiment, the above techniques may be performed by computer system 500 in response to processor 504 executing one or more sequences of one or more instructions contained in main memory 516. These instructions may be read into main memory 516 from another machine-readable medium, such as a storage device. Execution of the sequences of instructions contained in main memory 516 may cause processors 502-506 and/or the validation device 509 to perform the process steps described herein. In alternative embodiments, circuitry may be used in place of or in combination with the software instructions. Thus, embodiments of the present disclosure may include both hardware and software components.

Various embodiments may be implemented fully or partially in software and/or firmware. This software and/or firmware may take the form of instructions contained in or on a non-transitory computer-readable storage medium. Those instructions may then be read and executed by one or more processors to enable the performance of the operations described herein. The instructions may be in any suitable form, such as, but not limited to, source code, compiled code, interpreted code, executable code, static code, dynamic code, and the like. Such a computer-readable medium may include any tangible non-transitory medium for storing information in a form readable by one or more computers, such as but not limited to read-only memory (ROM); random access memory (RAM); magnetic disk storage media; optical storage media; a flash memory, etc.

A machine-readable medium includes any mechanism for storing or transmitting information in a form (e.g., software, processing application) readable by a machine (e.g., a computer). Such media may take the form of, but is not limited to, non-volatile media and volatile media and may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 606 (not shown) may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in main memory 516, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a system. The system also includes an optical device operable to emit or absorb light, where the optical device includes a lens having an outer surface. The system also includes a camera positioned in a line of sight of the optical device, where the camera is operable to capture one or more images of the optical device. The system also includes a computer system in communication with to the camera and operable to calculate a validation score for a captured image of the one or more images and to validate the optical device based on a validation state generated using the calculated validation score. Other embodiments of this aspect include corresponding computer systems, apparatus, and computer programs recorded on one or more computer storage devices, each configured to perform the actions of the methods.

Implementations may include one or more of the following features. The system where the optical device includes a camera, a light detection and ranging (LIDAR), a radar, or a vehicle light. The computer system is operable to detect a number of obstructed pixels in the captured image due to obstruction detected on the outer surface of the lens of the optical device. The validation score is associated with the number of obstructed pixels on the outer surface of the lens of the optical device. The computer system is operable to detect an active area of the lens of the optical device based on the captured image. The validation score is a cosmetic correlation to cleaning metric (CCCM) score. The validation state includes a failed state or a passing state. The computer system is operable to: compare the validation score to a validation threshold; and set the validation state to a failed state based on the validation score being less than the validation threshold. The computer system is operable to: compare the validation score to a validation threshold; and set the validation state to a passing state based on the validation score being greater than or equal to the validation threshold. The system further including a glare shield to prevent image glare due to lighting. Implementations of the described techniques may include hardware, a method or process, or computer software on a computer-accessible medium.

One general aspect includes a method. The method also includes capturing, by one or more processors, an image of an optical device placed at a distance in a line of sight of a camera. The method also includes detecting a lens area of the optical device in the captured image. The method also includes cropping an active area of the lens area in the captured image. The method also includes evaluating a number of obstructed pixels within the active area. The method also includes calculating a validation score based on the number of obstructed pixels. The method also includes generating a validation state associated with the optical device based on the validation score. Other embodiments of this aspect include corresponding computer systems, apparatus, and computer programs recorded on one or more computer storage devices, each configured to perform the actions of the methods.

Implementations may include one or more of the following features. The method where the method further includes detecting the number of obstructed pixels based on an obstruction on an outer surface of the lens area of the optical device. The optical device includes a camera, a light detection and ranging (LIDAR), a radar, or a vehicle light. The validation score is associated with the number of obstructed pixels on an outer surface of the lens area of the optical device. The validation score is a cosmetic correlation to cleaning metric (CCCM) score. The validation state is a failed state or a passing state. The method further includes: comparing the validation score to a validation threshold; and setting the validation state to a failed state based on the validation score being less than the validation threshold. The method further includes: comparing the validation score to a validation threshold; and setting the validation state to a passing state based on the validation score being greater than or equal to the validation threshold. Implementations of the described techniques may include hardware, a method or process, or computer software on a computer-accessible medium.

One general aspect includes a non-transitory computer-readable medium storing computer-executable instructions which when executed by one or more processors result in performing operations. The non-transitory computer-readable medium storing computer-executable instructions also includes capturing, by one or more processors, an image of an optical device placed at a distance in a line of sight of a camera. The non-transitory computer-readable medium storing computer-executable instructions also includes detecting a lens area of the optical device in the captured image. The non-transitory computer-readable medium storing computer-executable instructions also includes cropping an active area of the lens area in the captured image. The non-transitory computer-readable medium storing computer-executable instructions also includes evaluate a number of obstructed pixels within the active area. The non-transitory computer-readable medium storing computer-executable instructions also includes calculate a validation score based on the number of obstructed pixels. The non-transitory computer-readable medium storing computer-executable instructions also includes generate a validation state associated with the optical device based on the validation score. Other embodiments of this aspect include corresponding computer systems, apparatus, and computer programs recorded on one or more computer storage devices, each configured to perform the actions of the methods.

Implementations may include one or more of the following features. The non-transitory computer-readable medium where the operations further include detecting the number of obstructed pixels based on an obstruction on an outer surface of the lens area of the optical device. Implementations of the described techniques may include hardware, a method or process, or computer software on a computer-accessible medium.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

The word “exemplary” is used herein to mean “serving as an example, instance, or illustration.” Any embodiment described herein as “exemplary” is not necessarily to be construed as preferred or advantageous over other embodiments.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or any other manner.

It is understood that the above descriptions are for purposes of illustration and are not meant to be limiting.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

What is claimed is:

1. A system comprising:
an optical device operable to emit or absorb light, wherein the optical device comprises a lens having an outer surface;
a camera positioned in a line of sight of the optical device, wherein the camera is operable to capture one or more images of the optical device; and
a computer system in communication with to the camera and operable to calculate a validation score for a captured image of the one or more images and to validate the optical device based on a validation state generated using the calculated validation score.

2. The system of claim 1, wherein the optical device comprises a camera, a light detection and ranging (LIDAR), a radar, or a vehicle light.

3. The system of claim 1, wherein the computer system is operable to detect a number of obstructed pixels in the captured image due to obstruction detected on the outer surface of the lens of the optical device.

4. The system of claim 3, wherein the validation score is associated with the number of obstructed pixels on the outer surface of the lens of the optical device.

5. The system of claim 1, wherein the computer system is operable to detect an active area of the lens of the optical device based on the captured image.

6. The system of claim 1, wherein the validation score is a cosmetic correlation to cleaning metric (CCCM) score.

7. The system of claim 1, wherein the validation state comprises a failed state or a passing state.

8. The system of claim 1, wherein the computer system is operable to:
compare the validation score to a validation threshold; and
set the validation state to a failed state based on the validation score being less than the validation threshold.

9. The system of claim 1, wherein the computer system is operable to:
compare the validation score to a validation threshold; and
set the validation state to a passing state based on the validation score being greater than or equal to the validation threshold.

10. The system of claim 1, further comprising a glare shield to prevent image glare due to lighting.

11. A method comprising:
capturing, by one or more processors, an image of an optical device placed at a distance in a line of sight of a camera;
detecting a lens area of the optical device in the captured image;
cropping an active area of the lens area in the captured image;
evaluating a number of obstructed pixels within the active area;
calculating a validation score based on the number of obstructed pixels; and
generating a validation state associated with the optical device based on the validation score.

12. The method of claim 11, wherein the method further comprises detecting the number of obstructed pixels based on an obstruction on an outer surface of the lens area of the optical device.

13. The method of claim 11, wherein the optical device comprises a camera, a light detection and ranging (LIDAR), a radar, or a vehicle light.

14. The method of claim 11, wherein the validation score is associated with the number of obstructed pixels on an outer surface of the lens area of the optical device.

15. The method of claim 11, wherein the validation score is a cosmetic correlation to cleaning metric (CCCM) score.

16. The method of claim 11, wherein the validation state is a failed state or a passing state.

17. The method of claim 11, wherein the method further comprises:
comparing the validation score to a validation threshold; and
setting the validation state to a failed state based on the validation score being less than the validation threshold.

18. The method of claim 11, wherein the method further comprises:
comparing the validation score to a validation threshold; and
setting the validation state to a passing state based on the validation score being greater than or equal to the validation threshold.

19. A non-transitory computer-readable medium storing computer-executable instructions which when executed by one or more processors result in performing operations comprising:
capturing, by one or more processors, an image of an optical device placed at a distance in a line of sight of a camera;
detecting a lens area of the optical device in the captured image;
cropping an active area of the lens area in the captured image;
evaluate a number of obstructed pixels within the active area;
calculate a validation score based on the number of obstructed pixels; and
generate a validation state associated with the optical device based on the validation score.

20. The non-transitory computer-readable medium of claim 19, wherein the operations further comprise detecting the number of obstructed pixels based on an obstruction on an outer surface of the lens area of the optical device.
